(19) United States
(12) Patent Application Publication
(10) Pub. No.: US 2005/0210500 A1
(43) Pub. Date: Sep. 22, 2005

(54) Method and apparatus for providing conditional access to recorded data within a broadband communication system

(76) Inventor: Christopher J. Stone, Newtown, PA (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 10/805,797

(22) Filed: Mar. 22, 2004

(51) Int. Cl. H04N 7/167; H04N 7/16

(52) U.S. Cl. 725/31; 725/25

(57) ABSTRACT

A method (300) for providing conditional access to data. A conditional access system (24) is responsive to subscriber devices (14, 20), and the data (52) is stored on a recording medium (50) and encrypted using an encryption key (54) when the recording medium (50) is detachably coupled to a first subscriber device (14). The method includes: based on a request on behalf of a second subscriber device for access to the data, arranging (302) for the conditional access system to authenticate the second subscriber device; and arranging (304) for the conditional access system to transfer the encryption key to the second subscriber device. The encryption key is usable by the second subscriber device to decrypt the data when the recording medium is detachably coupled thereto, and access to the decrypted data by the second subscriber device is restricted in a manner specified by the conditional access system.

### FIELD OF THE INVENTION

Aspects of this invention relate generally to conditional data access, and, more particularly, to a method and apparatus for providing conditional access to recorded data within a broadband communication system.

### BACKGROUND OF THE INVENTION

Program providers such as television networks and stations, studios, Internet broadcasters and service providers, cable operators, satellite operators and the like, deliver programming to consumers via digital or analog signals. Personal recording devices such as internal/external hard drives (for example, personal video recorders (“PVRs”), digital video recorders, digital versatile recorders (“DVRs”), audio/video hard disk devices (“AVHDDs”), and other devices), video cassette recorders (“VCRs”), personal computer/television (PC/TV) devices, and TiVO®, along with other recording devices, which may stand alone, or be included in devices such as set-top boxes, among other devices, allow consumers to control the recording of programming, and to view or otherwise receive recorded programs for personal use at a later time.

Consumers may desire to receive recorded programming in a variety of manners—often, consumers wish to use other subscriber devices or consumer appliances to render the programming, such as remotely located set-top boxes, and other types of wired or wireless devices, which may access the medium upon which the recorded programming is stored. Program providers may also be interested in delivering content that may be used by multiple devices, but are also concerned with reducing the likelihood of illegal sharing of content protected by enforceable intellectual property rights.

One way program providers protect recorded programming is to require encryption of the programming prior to recording. The programming is generally encrypted in a manner that restricts use of the recorded programming to the device that originally received the recorded programming-using an encryption key associated with the receiving device, for example. Consumers may then be significantly restricted as to how they use the recorded programming, and may be unable to use the recorded programming on other devices.

There are, therefore, needs for methods, computer programs, and apparatuses for providing conditional access to recorded programming, which enable consumers to receive the recorded programming using more than one device, and which also ensure protection of intellectual property rights relating to the recorded programming.

### SUMMARY OF THE INVENTION

According to one aspect of the present invention, a method for providing conditional access to data operates within a broadband communication system. The broadband communication system has a conditional access system responsive to a plurality of subscriber devices, and the data is stored on a recording medium when the recording medium is detachably coupled to a first subscriber device and encrypted using an encryption key associated with the first subscriber device. The method includes: based on a request on behalf of a second subscriber device for access to the data, arranging for the conditional access system to authenticate the second subscriber device; and after authentication of the second subscriber device, arranging for the conditional access system to transfer the encryption key to the second subscriber device. The encryption key is usable by the second subscriber device to decrypt the data when the recording medium is detachably coupled to a second subscriber device, and access to the decrypted data by the second subscriber device restricted in a manner specified by the conditional access system.

Authentication of the second subscriber device may involve receiving a predetermined identifier from the second subscriber device, and prior to arranging for transfer of the encryption key to the second subscriber device, the second subscriber device may be required to pay a fee.

The broadband communication system may be a one- or two-way cable television system, and the subscriber devices may be set-top boxes. The data may be protected by intellectual property rights of a third party. The recording medium, which may be an external personal video recorder, may be detachably coupled to the subscriber devices via a serial bus implementation in compliance with the Institute of Electrical and Electronics Engineers 1394 set of specifications. The encryption key may be created by the first subscriber device or the conditional access system.

According to another aspect of the present invention, a computer-readable medium is encoded with a computer program which, when loaded into a processor, implements the foregoing method. The processor may be associated with the conditional access system, the first subscriber device, or the second subscriber device.

According to a further aspect of the present invention, an apparatus provides conditional access to data within a broadband communication system. The broadband communication system has a conditional access system responsive to a plurality of subscriber devices, and the data is stored on a recording medium when the recording medium is detachably coupled to a first subscriber device, and encrypted using an encryption key associated with the first subscriber device. The apparatus includes: a computer-readable storage medium; and a processor responsive to the computer-readable storage medium and to a computer program, the computer program, when loaded into the processor, is operative to: based on a request on behalf of a second subscriber device for access to the data, arrange for the conditional access system to authenticate the second subscriber device; and arrange for the conditional access system to transfer the encryption key to the second subscriber device after authentication of the second subscriber device, the encryption key usable by the second subscriber device to decrypt the data when the recording medium is detachably coupled to the second subscriber device.

According to a still further aspect of the present invention, a system provides conditional access to data within a broadband communication network. The data is stored on a recording medium detachably couplable to a plurality of subscriber devices, and encrypted using an encryption key associated with a first subscriber device. The system includes: a network communications interface for forwarding a request for access to the data by a second subscriber device; and an information processing system in communication with the network communications interface, for receiving and processing the request forwarded by the network communications interface, and, based on the request, performing a method comprising: arranging for authentication of the second subscriber device by a conditional access system within the broadband communication network; and after authentication of the second subscriber device, arranging for the conditional access system to transfer the encryption key to the second subscriber device, the encryption key usable by the second subscriber device to decrypt the data when the recording medium is detachably coupled to the second subscriber device. The system may be a headend of a cable television system, or a cable set-top box.

### BRIEF DESCRIPTION OF THE DRAWINGS

FIG. 1 is a block diagram of a broadband communication system, in which various aspects of the present invention may be used.

FIG. 2 is a block diagram of a subscriber device responsive to the broadband communication system shown in FIG. 1, in which various aspects of the present invention may be used.

FIG. 3 is a flowchart of a method for providing conditional access to recorded data within a broadband communication system, in accordance with an aspect of the present invention.

### DETAILED DESCRIPTION

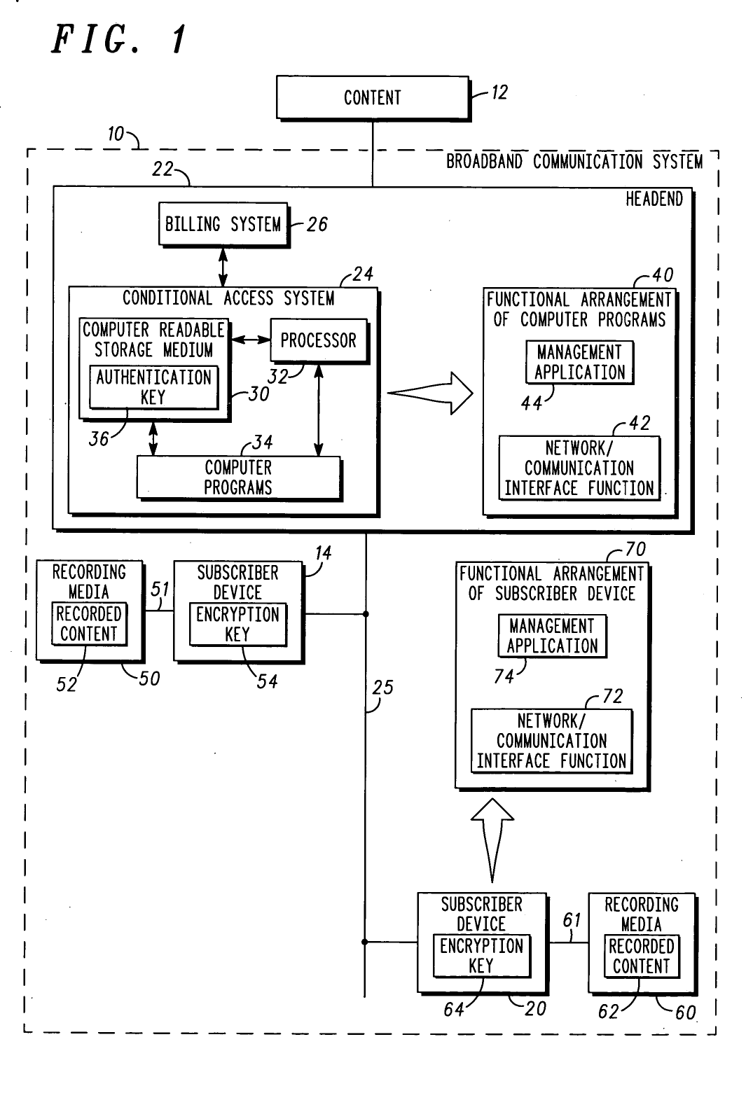

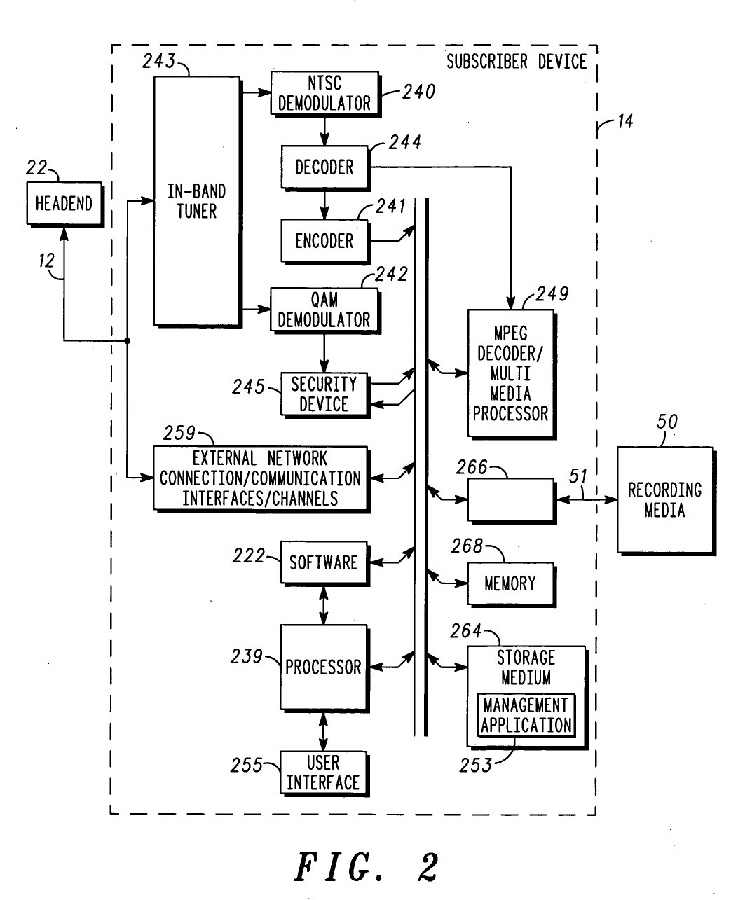

Turning now to the drawings, where like numerals designate like components, FIG. 1 is a block diagram of a broadband communication system 10, which delivers content 12 (such as any pre-recorded or live analog or digital electronic signals representing an image and/or audio, software, or other data, in any format) to one or more of a plurality of subscriber devices (two subscriber devices, 14 and 20, are shown) via headend 22 and network 25. Subscriber devices 14 and 20 are detachably coupled to recording media 50 and 60, respectively, via recording media interfaces 51 and 61, respectively. Recording medium 50 includes recorded content 52 thereon, which is encrypted with encryption key 54, which may be located/stored on subscriber device 14 (for example, in security device 245, discussed further below in connection with FIG. 2, or in memory 268, also discussed further below in connection with FIG. 2), or on headend 22, while recording medium 60 includes recorded content 62 thereon, which is encrypted with encryption key 64. Headend 22 includes, among other things, a conditional access system (“CAS”) 24, and a billing system 26 in communication with CAS 24. Application servers (not shown) may also be in communication with headend 22, to provide a variety of sources for content 12, and/or services, such as interactive television, Internet services, telephone services, video-on-demand services, and the like.

During normal operation of system 10, a consumer using a particular subscriber device 14 or 20 may wish to view or otherwise use recorded content, 62 or 52, respectively, that was recorded using another subscriber device. To receive the desired recorded content, a consumer using subscriber device 14 may detach recording media 50 therefrom, and couple recording medium 60 thereto; likewise, a consumer using subscriber device 20 may detach recording medium 60 therefrom, and attach recording medium 50 thereto.

As shown, system 10 is a cable system operated by a multiple service operator (“MSO”), content 12 is a digital or analog programming source supplied by the MSO, subscriber devices 14 and 20 are cable set-top boxes (for example, Motorola's DCT 6200 series digital set-top terminal(s)), network 25 is a hybrid fiber-optic/coax network providing two-way interactive communications services, and headend 22 consists of a plurality of reception and retransmission equipment specifically designed to distribute audio/video/data services, in either a secure and/or non-secure fashion, over a hybrid fiber-optic/coax network. It will be understood, however, that system 10, and connections throughout network 25, may be any public or private, wired or wireless, content transmission infrastructure or technology for delivery of content 12, including but not limited to a fiber-optic network, a coaxial cable network, a satellite network, a cellular network, a wireless network, the Internet, a television network, a radio network, a copper wire network, or any other existing or future transmission infrastructure or technology, or any combination thereof, operated by any type of program provider, such as a television network or station, a studio, an Internet broadcaster or service provider, a cable operator, or a satellite operator. Network 25 may also include layers of other networks. It will also be understood that subscriber devices 14 and 20 may be any device or combination of devices responsive to system 10, capable of receiving, storing and rendering content 12, including but not limited to home- or office-based personal computer systems, receiving, recording or playback devices such as internal/external hard drives (for example, personal video recorders (“PVRs”), digital video recorders (“DVRs”), digital versatile recorders (“DVRs”), audio/video hard disk devices (“AVHDDs”), and other devices), digital video cassette recorders (“VCRs”), digital versatile disk (“DVD”) players, CD-ROM recorders, MP3 recording devices, stereo systems, personal computer/television devices, and other types of wired or wireless devices, such as personal digital assistants, radiofrequency communication devices, and any other type of consumer appliance, either standing alone, or included in other devices.

Headend 22 receives content 12, and facilitates transfer of content 12 to subscriber devices 14 and 20, via network 25, provisioning consumer services such as interactive television, Internet services, telephone services, video-on-demand services, and other services now known or later developed. Channels (not shown), such as analog and digital upstream and downstream channels, are controlled by headend 22 using well-known methods and techniques. Channels carry clear, scrambled, unencrypted and/or encrypted signals and data to and from subscriber devices 14 and 20 (although any other medium may be used to transfer content 12, physically, electronically, or otherwise, such as CD- or DVD-ROM, or other storage media, such as disk drives). Headend 22 has a well-known internal arrangement, including items such as one or more multiplexers, one or more modulators, and one or more servers (CAS 24 is shown), which in turn include computer-readable storage media, processors, computer programs, disk controllers, and network adapters or interfaces, configured in well-known manners using well-known techniques, to implement the functions of headend 22.

CAS 24, which may include or more servers, is operative to communicate with billing system 26 and subscriber devices 14 and 20, to establish security associations between headend 22 and subscriber devices 14 and 20. During normal operation, CAS 24 encrypts content 12 prior to transmission to subscriber devices 14 and 20 (although in some cases content 12 may be pre-encrypted, or not encrypted at all), determines whether a particular subscriber device is authorized to receive certain content 12, coordinates billing for subscriber devices 14 and 20 via communications with billing system 26, and communicates with subscriber devices 14 and 20 via messages, using a variety of well-known methods and techniques. In one example, a message stream protocol may be utilized, where messages may be encapsulated within MPEG cells, using well-known methods and techniques. Client-server architectures, such as those in which computer application programs are configured to cause clients, such as subscriber devices, to request services from server-based service providers, such as CAS 24, may be employed to provide security for data shared between CAS 24 and subscriber devices 14 and 20.

As shown, CAS 24 is a server having a well-known internal arrangement, including items such as a computer-readable storage medium 30, a processor 32, and computer programs 34. CAS 24 may further include other well-known elements (not shown), configured in well-known manners using well-known techniques, such as: physical memory; additional storage devices; disk controllers; network adapters or interfaces; and human-device interfaces.

Computer-readable storage medium 30 stores, among other things, a database (not shown) of unique identifiers for subscriber devices, for example, serial numbers, internet protocol addresses, account numbers, passwords, PINs, authentication keys 36 (discussed further below) and other subscriber device identifiers.

Authentication keys 36 represent any key-based means or protocols for providing privacy or security for data shared between system 10 and subscriber devices 14 and 20. Authentication keys 36 are preferably based on public key technology, although authentication keys 36 may also be based on symmetric key technology, asymmetric key technology, a blend thereof, or other existing or future key-based authentication/encryption technologies. CAS 24 stores public keys associated with CAS 24, and may, under certain circumstances, store public and private authentication and/or encryption keys for subscriber devices 14 and 20. Private keys for subscriber devices 14 and 20, such as keys 54 and 64, respectively, may be assigned by a manufacturer (via smart-cards, for example), or created by subscriber devices 14 and 20. Subscriber device private keys may be retained by the subscriber devices, or may be forwarded to, and/or stored by, CAS 24. Alternatively, private keys for subscriber devices 14 and 20 may be both assigned and stored by CAS 24.

Processor 32 is responsive to computer-readable storage medium 30 and to computer programs 34. Computer programs 34 are generally organized into functional components. Block 40 illustrates certain aspects of the functional arrangements of computer programs 34 that pertain to the secure delivery of content 12 from CAS 24 to subscriber devices 14 and 20, and authorization for decryption and use of recorded content by subscriber devices 14 and 20.

Network/communications interface function 42, which may support, for example, a modem or other network connection support device(s) or program(s), is responsive to, and responsible for, mechanics of communication between a key management application 44 (discussed further below), a key management application 253 (discussed further below, in connection with subscriber device 14) a security device 245 (discussed further below, in connection with subscriber device 14), a key management application 74 (also discussed further below, in connection with subscriber device 20), and/or an embedded security device (not shown) associated with system 10, and may be selected or implemented by one skilled in the art. Communication between CAS 24 and subscriber devices 14 and 20 may occur in any desired channel, using any desired protocol, for example a Digital Broadband Delivery System: Out of Band Transport as defined in the Society of Cable Telecommunication Engineers specification SCTE55-1 or SCTE55-2.

Key management application 44 represents the server component, or agent, of a computer program which, when executed, is capable of implementing one or more aspects of the process of delivering content 12 from CAS 24 to one or more subscriber devices 14 and 20, and the process of authenticating and/or authorizing subscriber devices 14 and 20 to decrypt and use recorded content stored on recording media detachably coupled to the subscriber devices. Key management application 44 may support, for example, composition, transmission, encryption, encoding, and compression of outbound communications, and reception, decompression, decoding, decryption and presentation of inbound communications.

More specifically, key management application 44 allows subscriber devices 14 and 20 to authenticate themselves to CAS 24, through the use of authentication keys 36. During initial receipt of content 12, messages are sent by CAS 24 to subscriber devices, using well-known methods and techniques. The messages contain authentication keys 36 that are used by authorized subscriber devices to decrypt content 12 as it is received. When subscriber devices store received content 12 for later use, CAS 24 may store certain private encryption keys used by the subscriber devices to encrypt the received content 12 prior to storage.

Key management application 44 may be stored in computer-readable memory 30, and implemented according to well-known software engineering practices for component-based software development. It will be understood, however, that key management application 44 may be hardware, software, firmware, or any combination thereof.

FIG. 2 is a block diagram of subscriber device 14, which is also generally representative of subscriber device 20 (shown in FIG. 1). Subscriber device 14 is externally detachably coupled to recording medium 50, such as an external hard drive, a VCR, a PC/TV device, or any other type of portable recording medium now known or later developed, via recording media interface 51. Recording media interface 51 may be a serial bus implementation in compliance with the Institute of Electrical and Electronics Engineers (“IEEE”) 1394 series of standards, such as a Firewire, iLink, or DTV Link products, a universal serial bus (“USB”), an Ethernet connection, a wireless connection (such as an IEEE-802.11a connection, or a Bluetooth connection), or any other suitable digital interface. Recording medium 50 is used for recording selected content received by subscriber device 14. Recording media interface 51 allows for the replacement of recording medium 50 with another recording medium, such as recording medium 60 (shown in FIG. 1) associated with subscriber device 20. Recording medium interface 51 also allows for the addition of one or more recording mediums that work in conjunction with recording medium 50, thus recoding medium 50 and recording medium 60 may coexist on the same subscriber device 14 allowing the user to simultaneously access content 52 and content 62.

Internally, subscriber device 14 may also include a storage medium, such as storage medium 264. Storage medium 264 may be any device, now known or later developed, capable of recording data, including but not limited to a hard disk drive, all types of compact disks and digital videodisks, a magnetic tape, a home router, or a server.

Subscriber device 14 further includes one or more interfaces for communication with other devices. For example, an external network connection/communication interface 259, which supports devices such as modems (using various communication protocols and techniques, for example, SCTE55-1, SCTE55-2, DOCSIS, EuroDOCSIS, DSL, or ISDN, among others), streaming media players and other network connection support devices and/or software, may be coupled through local or wide area networks (not shown) to program providers and providers of other content. Network connection/communications interface 259 is also responsive to, and responsible for, mechanics of communication between key management application 253 (discussed further below) and/or security device 245 (also discussed further below), and key management application 44, and may be selected or implemented by one skilled in the art.

Subscriber device 14 still further includes an in-band tuner 243, which tunes to a channel signal selected by a consumer (not shown) via user interface 255. User interface 255 may be any type of known or future device or technology allowing the consumer to select content 12, such as channels or programming, the consumer wishes to receive, such as a remote control, mouse, microphone, keyboard, or display.

NTSC Demodulator 240 and QAM Demodulator 242 are responsive to in-band tuner 243. QAM Demodulator 242 may be any type of digital demodulator device that may include, but is not limited to, an ATSC demodulation device. NTSC Demodulator 240 includes components responsive to receive analog versions of a channel signal. QAM Demodulator 242 includes components responsive to receive digital versions of a channel signal. Security Device 245 is responsive to decrypt authorized encrypted content 12.

Security device 245 may also be utilized to encrypt analog content 12 encoded by encoder 241 or to re-encrypt digital content 12 prior to the content being recorded to a storage medium. Security device 245 may further be utilized to decrypt recorded content that was previously encrypted, when encrypted recorded content is played back from a storage medium. Authentication keys may be embedded within security device 245, although transfer of the keys to other devices may not be practical or possible in some cases.

Decoder 244 is responsive to NTSC Demodulator 240. Decoder 244 is operative for decoding information, such as video information, and converting it into a digital representation of the received information. Information that may require format translation or modification for compatibility with capabilities of storage medium 264 or recording medium 50 may be passed to encoder 241 for formatting. Information that is in a format preferred for use by Multi Media Processor 249 may be passed directly to Multi Media Processor 249.

Encoder 241 is operative to perform predetermined coding techniques to produce an encoded signal for transmission, or for storage in recording medium 50 or storage medium 264. In general, protection against unauthorized use and distribution of content 12 recorded by subscriber device 14 on recording medium 50 is provided by a requirement imposed by CAS 24 that, prior to recording content 12, subscriber device 14 use a private encryption key to encrypt content 12. Encoder 241, for example, may use predetermined encryption techniques to form recorded content 52, combining an encryption key 54 associated with subscriber device 14 with received content 12, to form ciphertext, decryptable and usable only by subscriber 14, and by those having access—authorized by CAS 24—to encryption key 54.

As a second example, security device 245, may use predetermined encryption techniques to form recorded content 52, combining an encryption key 54 associated with subscriber device 14 with received content 12, to form ciphertext, decryptable and usable only by subscriber 14, and by those having access—authorized by CAS 24—to encryption key 54.

As a third example, processor 239, utilizing software 222, may use predetermined encryption techniques to form recorded content 52, combining an encryption key 54 associated with subscriber device 14 with received content 12, to form ciphertext, decryptable and usable only by subscriber 14, and by those having access—authorized by CAS 24—to encryption key.

MPEG Decoder/Multi-Media Processor 249 is operative to perform predetermined coding techniques to arrange video information into formats displayable by a display device (not shown). Information that is retrieved and played back from storage medium 264 or recording medium 50 is passed to MPEG Decoder/Multi Media Processor 249. MPEG Decoder/Multi-Media Processor 249 is responsive to receive broadcast or recorded signals, format received video into its Red-Green-Blue (RGB) components, and transmit data to a display device (not shown), in response to instructions from user interface 255. MPEG Decoder/Multi-Media Processor 249 (and/or security device 245) is also responsible for identifying when recorded content on a recording medium coupled to subscriber device 14 via recording media interface 51 is encrypted, and for initiating processes leading to decryption of the recorded content prior to use of the recorded content.

Internal arrangements of MPEG Decoder/Multi-Media Processor 249 are well known, and may include analog-to-digital converters, one or more storage media and/or buffers, and general or special-purpose processors or application-specific integrated circuits, along with demultiplexors for demultiplexing and/or synchronizing at least two transport streams, for example, video and audio. Video and audio decoders and/or analog and digital decoders may be separate, with communication between separate decoders allowing for synchronization, error correction and control.

Processor 239 and software 222 are illustrated functionally, and are responsive to various elements of subscriber device 14, including demodulators 240 and 242, encoder 241, security device 245, storage medium 264, decoder 249, and recording media coupled to subscriber device 14 via recording media interface 51.

One component of software 222, key management application 253 (as shown, stored in storage medium 264), represents the client component, or agent, of a computer program which, when loaded into a processor, such as processor 239, and executed, is capable of implementing one or more aspects of the processes of receiving and encrypting content 12 from CAS 24, and of obtaining authentication and/or authorization from CAS 24—via interaction with key management application 44—for decryption and use of recorded content stored on a particular recording medium coupled to subscriber device 14 via recording media interface 51. Specifically, when requesting the right to decrypt and use recorded content, key management application 253 allows subscriber device 14 to authenticate itself to CAS 24 through the use of authentication keys 36. Key management application 253 may also support, for example, composition, transmission, encryption, encoding, and compression of outbound communications, and reception, decompression, decoding, decryption and presentation of inbound communications.

Key management application 253 may be stored in computer-readable memory 264, and implemented according to well-known software engineering practices for component-based software development (although it will be understood that key management application 253 may be hardware, software, firmware, or any combination thereof).

Referring again to FIG. 1, subscriber device 20 is similar in configuration to subscriber device 14 (shown in, and described in connection with, FIG. 2). Subscriber device 20 is externally detachably coupled to recording medium 60 via recording media interface 61, which may be a FireWire® serial bus implementation in compliance with the Institute of Electrical and Electronics Engineers (“IEEE”) 1394 series of standards. Like recording medium 50, recording medium 60 may be an external hard drive, a VCR, a PC/TV device, or any other type of portable recording medium now known or later developed. Recording medium 60 is used for recording selected content received by subscriber device 20. Recording media interface 61 allows for the replacement of recording medium 60 with another recording medium, such as recording medium 50.

In general, protection against unauthorized use and distribution of content 12 recorded by subscriber device 20 on recording medium 60 is provided by a requirement imposed by CAS 24 that, prior to recording content 12, subscriber device 20 must use a private encryption key 64 to encrypt content 12. Subscriber device 20, for example, may use predetermined encryption techniques to form recorded content 62, combining an encryption key 64 associated with subscriber device 20 with received content 12, to form ciphertext, decryptable and usable only by subscriber 20, and by those having access-authorized by CAS 24—to encryption key 64.

Block 70 illustrates certain aspects of the functional arrangements of subscriber device 20 that relate to access by other subscriber devices, such as subscriber device 14, to recorded content 62, encrypted using encryption key 64. Network/communication interface function 72, which may support, for example, a modem or other network connection support device(s) or program(s), is responsive to, and responsible for, mechanics of communication between key management application 74 (discussed further below) and key management application 44, and may be selected or implemented by one skilled in the art.

Key management application 74 represents the client component, or agent, of a computer program which, when loaded into a processor, and executed, is capable of implementing one or more aspects of the processes of receiving and encrypting content 12 from CAS 24, and of obtaining authentication and/or authorization from CAS 24—via interaction with key management application 44—for decryption and use of recorded content stored on a particular recording medium coupled to subscriber device 20 via recording media interface 61. Specifically, when requesting the right to decrypt and use recorded content, key management application 74 allows subscriber device 20 to authenticate itself to CAS 24 through the use of authentication keys 36. Key management application 74 may also support, for example, composition, transmission, encryption, encoding, and compression of outbound communications, and reception, decompression, decoding, decryption and presentation of inbound communications.

Key management application 74 may be stored in a computer-readable memory, and implemented according to well-known software engineering practices for component-based software development (although it will be understood that key management application may be hardware, software, firmware, or any combination thereof).

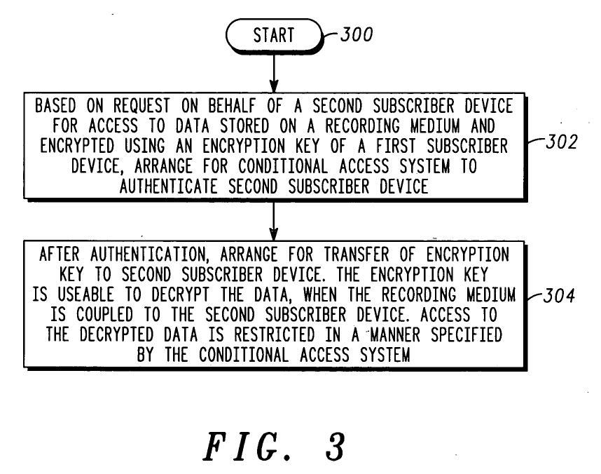

FIG. 3 is a flowchart of a method for providing conditional access to recorded data. The method is used within a broadband communication system, such as system 10, having a conditional access system, such as CAS 24. The data includes recorded content, such as recorded content 62, which was stored on a recording medium, such as recording medium 60, when the recording medium was coupled to a first subscriber device, such as subscriber device 20, and which was encrypted using an encryption key associated with the first subscriber device. A consumer desiring to use the recorded data may detach the recording medium from the first subscriber device, and attach it to a second subscriber device, such as subscriber device 14. The method begins at block 300, and continues at block 302, where, based on a request on behalf of the second subscriber device for access to the data, it is arranged for the conditional access system to authenticate the second subscriber device.

When subscriber device 14 detects that recorded content 62 is encrypted with encryption key 64, for example, either MPEG Decoder/Multi-Media Processor 249, and/or security device 245 identifies encrypted content (for example, by detecting encrypted packet ids), subscriber device 14 itself may request access to encryption key 64 from CAS 24. In a system having both upstream and downstream communication with conditional access controller 24, a message, such as a command within a message stream protocol, which may be signed using the private or public authentication key (that may be found among authentication keys 36) associated with subscriber device 14, may be used by subscriber device 14 to contact CAS 24 to request access to recorded content 66, and/or request encryption key 64.

Alternatively, in a system having only downstream communication with conditional access controller 24, subscriber device 14 may interact with a consumer (for example, via an on-screen message, a voice prompt, or another type of visible or audible cue) to request that the consumer contact an administrator of system 10 to initiate authentication of subscriber device 14 to use recorded content 62 For authentication purposes, CAS 24 may have stored (in storage medium 30, for example) a list of subscribers authorized to request access to data recorded by other subscribers, or may maintain other information used to conduct authentication, such as a database of registered subscribers, along with other information associated therewith, such as authentication and/or encryption keys, serial numbers, PIN numbers, internet protocol addresses, and other relevant characteristics of subscriber devices. CAS 24 may request that subscriber devices desiring to receive or supply recorded content supply provide certain characteristics, such as PIN numbers, for purposes of identification and/or authentication.

At block 304, after authentication of the second subscriber device, it is arranged for the conditional access system to transfer the encryption key to the second subscriber device. The encryption key is usable by the second subscriber device to decrypt the recorded, encrypted data, when the recording medium storing the data is coupled to the second subscriber device.

In the case where CAS 24 stores and/or assigns copies of private authentication or encryption keys associated with subscriber devices 14 and 20, transfer of the encryption key occurs when CAS 24 supplies encryption key 64 (along with other items or information needed to successfully decrypt recorded content 62) directly to subscriber device 14, via, for example, a command within a message stream protocol. If subscriber devices have not shared their private authentication or encryption keys with CAS 24, then CAS 24 may initiate key exchange messaging (via, for example, a command in a message stream protocol) with subscriber device 20, which may include authentication of subscriber device 20, to obtain encryption key 64 from subscriber device 20 for subsequent transfer to subscriber device 14.

The second subscriber device's access to the data is restricted in a manner specified by the conditional access system. CAS 24 may, for example: include a time expiration time on the use of encryption key 64; restrict the number of times encryption key 64 may be used by subscriber device 14 to decrypt recorded content 62; prohibit transfer of encryption key 64 by subscriber device 14; or prevent re-recording of decrypted content by subscriber device 14. These conditions and others associated with access to the data may be implemented to protect the intellectual property rights an operator of system 10, or of other third parties, in content 12. The second subscriber device may also be charged a fee for the right to decrypt and/or use the recorded content. The conditional access system may arrange for appropriate billing and/or fee collection via interaction with a billing system, such as billing system 26.

Thus, a solution for providing conditional access to recorded data within a broadband communication system has been described. Subject to restrictions imposed by, and authorization from, a conditional access system within the broadband communication system, consumers may use recorded content on multiple subscriber devices, such as set-top boxes, within or outside of the home, when a recording medium storing the recorded content is coupled to other subscriber devices. As an added advantage, if a subscriber device that originally recorded and encrypted certain content malfunctions, the consumer would still have access to the recorded content via another subscriber device.

The method illustrated in the flowchart of FIG. 3 may be implemented by any stored instructions. When loaded into a processor, such as processors 32, 239, or a processor associated with another subscriber device, such instructions would operate to implement aspects of providing conditional access to recorded, encrypted data described herein.

Although a specific architecture has been described herein, including specific functional elements and relationships, it is contemplated that the systems and methods herein may be implemented in a variety of ways. For example, functional elements may be packaged together or individually, or may be implemented by fewer, more or different devices, and may be either integrated within other products, or adapted to work with other products externally. For example, system 10 may be configured differently, or contain different or additional components, and CAS 24 and/or billing system 26 may be separate from headend 22. When one element is indicated as being responsive to another element, the elements may be directly or indirectly coupled.

It will also be appreciated that aspects of the present invention are not limited to any specific embodiments of computer software or signal processing methods. For example, one or more processors packaged together or with other elements of headend 22 or subscriber device 14 may implement functions of processors 22 and 239, respectively in a variety of ways. It will also be appreciated that computer programs 34, 222, and other functions indicated for implementation using computer programs, may be any stored instructions, in one or more parts, that electronically control functions set forth herein, and may be used or implemented by one or more elements, including one or more processors.

It will further be apparent that other and further forms of the invention, and embodiments other than the specific embodiments described above, may be devised without departing from the spirit and scope of the appended claims and their equivalents, and it is therefore intended that the scope of this invention will only be governed by the following claims and their equivalents.

1. A method (300) for providing conditional access to data (12/52) within a broadband communication system (10), the broadband communication system (10) having a conditional access system (24) responsive to a plurality of subscriber devices (14, 20), the data (52) stored on a recording medium (50) when the recording medium (50) is detachably coupled to a first subscriber device (14) and encrypted using an encryption key (54) associated with the first subscriber device, the method comprising:
based on a request on behalf of a second subscriber device (20) for access to the data (52), arranging (302) for the conditional access system (24) to authenticate the second subscriber device (20); and
after authentication of the second subscriber device (20), arranging (304) for the conditional access system (24) to transfer the encryption key (54) to the second subscriber device (24),
the encryption key (54) usable by the second subscriber device (20) to decrypt the data (52) when the recording medium (50) is detachably coupled to the second subscriber device (20), access to the decrypted data by the second subscriber device (20) restricted in a manner specified by the conditional access system (24).

2. The method according to claim 1, wherein the broadband communication system comprises (10) a cable television system.

3. The method according to claim 2, wherein the cable television system is an interactive two-way system.

4. The method according to claim 2, wherein the cable television system is a one-way system.

5. The method according to claim 2, wherein the first (14) and second (20) subscriber devices comprise set-top boxes.

6. The method according to claim 5, wherein the recording medium (50) is detachably couplable to the first (14) and second (20) subscriber devices via a serial bus implementation, at least in part in compliance with the Institute of Electrical and Electronics Engineers 1394 standard.

7. The method according to claim 6, wherein the recording medium (50) comprises an external personal video recorder.

8. The method according to claim 1, further comprising: prior to arranging for transfer of the encryption key (54) to the second subscriber device (20), arranging for payment of a fee by the second subscriber device (20).

9. The method according to claim 1, wherein the step of arranging for authentication of the second subscriber device (20) comprises arranging for the conditional access system (24) to receive a predetermined identifier from the second subscriber device (20).

10. The method according to claim 1, wherein the data (52) is protected by intellectual property rights of a third party.

11. The method according to claim 10, further comprising:
specifying an access condition associated with the data, the access condition based on the predetermined intellectual property rights.

12. The method according to claim 11, wherein the access condition is specified by the conditional access controller (24).

13. The method according to claim 12, wherein the step of arranging for authentication of the second subscriber device (20) comprises evaluating the access condition.

14. The method according to claim 13, wherein the use of the data (52) by the second subscriber device (20) is restricted in a manner specified by the access condition.

15. The method according to claim 1, wherein the encryption key (54) is created by one of the conditional access controller (24) and the first subscriber device (14).

16. A computer-readable medium (30, 264) encoded with a computer program (34, 222) which, when loaded into a processor (32, 239), implements the method of claim 1.

17. The computer-readable medium (30) according to claim 16, wherein the processor (32) is associated with the conditional access system (24).

18. The computer-readable medium (264) according to claim 16, wherein the processor (239) is associated with the first subscriber device (14).

19. The computer-readable medium according to claim 16, wherein the processor is associated with the second subscriber device (20).

20. An apparatus for providing conditional access to data (12/52) within a broadband communication system (10), the broadband communication system (10) having a conditional access system (24) responsive to a plurality of subscriber devices (14, 20), the data (52) stored on a recording medium (50) when the recording medium (50) is detachably coupled to a first subscriber device (14), and encrypted using an encryption key (54) associated with the first subscriber device (14), the apparatus comprising:
a computer-readable storage medium (30, 264); and
a processor (32, 239) responsive to the computer-readable storage medium (30, 264) and to a computer program (34, 222), the computer program (34, 222), when loaded into the processor (32, 239), operative to:
based on a request on behalf of a second subscriber device (20) for access to the data (52), arrange for the conditional access system (24) to authenticate the second subscriber device (20); and
arrange for the conditional access system (24) to transfer the encryption key (54) to the second subscriber device (20) after authentication of the second subscriber device (20), the encryption key (54) usable by the second subscriber device (20) to decrypt the data when the recording medium (50) is detachably coupled to the second subscriber device (20).

21. A system for providing conditional access to data (12/52) within a broadband communication network (10), the data (52) stored on a recording medium (50) detachably couplable to a plurality of subscriber devices (14, 20), and encrypted using an encryption key (54) associated with a first subscriber device (14), the system comprising:
a network communications interface (42, 259) for forwarding a request for access to the data by a second subscriber device (20); and
an information processing system (44, 253) in communication with the network communications interface (42, 259), for receiving and processing the request forwarded by the network communications interface (42, 259), and, based on the request, performing a method comprising:
arranging for authentication of the second subscriber device (20) by a conditional access system (24) within the broadband communication network (10); and
after authentication of the second subscriber device (20), arranging for the conditional access system (24) to transfer the encryption key (54) to the second subscriber device (20), the encryption key (54) usable by the second subscriber device (20) to decrypt the data when the recording medium (50) is detachably coupled to the second subscriber device (20).

22. The system according to claim 21, wherein the system comprises a headend (22) of a cable television system.

23. The system according to claim 21, wherein the system comprises the second subscriber device (20), and wherein the second subscriber device comprises a cable set-top box.
